(19) United States
(12) Patent Application Publication
(10) Pub. No.: US 2017/0203309 A1
(43) Pub. Date: Jul. 20, 2017

(54) Driven Turret Nozzle Assembly System and Method

(71) Applicant: Pentair Flow Technologies, LLC, Delavan, WI (US)

(72) Inventors: Joseph Krueger, Edina, MN (US); Jeff Hermes, Shoreview, MN (US)

(21) Appl. No.: 15/409,264

(22) Filed: Jan. 18, 2017

Related U.S. Application Data
(60) Provisional application No. 62/279,953, filed on Jan. 18, 2016.

(51) Int. Cl. B05B 1/16; B05B 12/12; B05B 15/06; B05B 12/08

(52) U.S. Cl. CPC B05B 1/16; B05B 12/081; B05B 12/12; B05B 15/061

(57) ABSTRACT

A driven turret nozzle assembly includes a main body, a turret rotatably coupled to and in fluid communication with the main body, nozzle bodies circumferentially spaced about the turret, and a driver operationally coupled to the turret to effect automated selective rotation of the turret. Actuation of the driver rotates the turret to move an active nozzle body into fluid communication with a fluid path defined through the main body and the turret.

### RELATED APPLICATION

This application claims priority under 35 U.S.C. §119 to U.S. Provisional Patent Application No. 62/279,953 filed on Jan. 18, 2016, the entire contents of which are incorporated herein by reference.

### BACKGROUND

The present disclosure is described in the context of turret-style nozzle arrangements for agricultural sprayers. More specifically, the present disclosure relates to nozzle systems incorporating a turret that is driven between desired positions.

Agricultural sprayers can be mounted to a motorized vehicle, such as a farm tractor. These sprayers typically include one or more tanks storing fluid (e.g., an agricultural fluid including crop protection chemicals such as fertilizers, herbicides, insecticides, fungicides, and the like) to be applied to an agricultural field. Fluid in the tank is pumped through pipes to a spray boom that includes multiple nozzle assemblies mounted along the spray boom. One particular type of nozzle assembly is a turret-style nozzle assembly, which includes multiple nozzle bodies (each typically including a spray tip) that can be rotated into and out of fluid communication with the fluid in the spray boom.

A traditional turret nozzle assembly can provide various benefits to effectively distribute the fluid over a desired area. For example, a turret nozzle assembly can include nozzle bodies with identical spray tips, such that if the spray tip of the active nozzle body becomes clogged a different nozzle body can be manually moved into the active position. In other configurations, each nozzle body can include a spray tip defining discrete fluid parameters (e.g., a maximum fluid flow rate, a fluid spray geometry/pattern, etc.), such that a turret nozzle assembly can be moved or indexed to position a particular nozzle body into the active position to achieve a desired result (e.g., a relatively wider fluid spray pattern). In conventional sprayers, however, each turret must be manually rotated individually and by hand, which is a time and labor intensive process, especially on larger spray booms having multiple turret nozzle assemblies.

Therefore, a need exists for an improved turret-style nozzle arrangement and a method of using the improved arrangement.

### SUMMARY

Some embodiments of the invention provide a driven turret nozzle assembly having a main body, a turret rotatably coupled to and in fluid communication with the main body, a plurality of nozzle bodies circumferentially spaced about the turret, and a driver operationally coupled to the turret to effect automated selective rotation of the turret. Actuation of the driver rotates the turret to move an active nozzle body of the plurality of nozzle bodies into fluid communication with a fluid path defined through the main body and the turret.

In another embodiment, a driven turret nozzle assembly system includes a driven turret nozzle assembly comprising a main body, a turret rotatably coupled to and in fluid communication with the main body, a plurality of nozzle bodies circumferentially spaced about the turret, and a driver operationally coupled to the turret to effect selective rotation of the turret. A controller is in communication with the driver and programmed to control, actuation of the driver to rotate the turret to move an active one of the plurality of nozzle bodies into an active position at which the active nozzle body is in fluid communication with a fluid path defined through the main body and the turret.

In a further embodiment, a method of operating a driven turret nozzle assembly system is provided. The system comprises a driven turret nozzle assembly including a main body, a turret rotatably coupled to and in fluid communication with the main body, a plurality of nozzle bodies circumferentially spaced about the turret, and a driver operationally coupled to the turret to effect rotation of the turret, a controller in communication with the driver and programmed to control actuation of the driver to rotate the turret, and a sensor in communication with the controller. The method includes the steps of: the controller receiving a parameter from the sensor; the controller comparing the parameter to an automated control scheme programed into and executed by the controller; and the controller actuating the driver to rotate the turret in accordance with a comparison between the automated control scheme and the parameter from the sensor.

### BRIEF DESCRIPTION OF THE DRAWINGS

FIG. 1 is a top isometric view of a driven turret nozzle assembly according to one embodiment of the invention.

FIG. 2 is a front elevation view of the example driven turret nozzle assembly shown in FIG. 1.

FIG. 3 is a back elevation view of the example driven turret nozzle assembly shown in FIG. 1.

FIG. 4 is a side elevation view of the example driven turret nozzle assembly shown in FIG. 1.

FIG. 5 is schematic of a system incorporating driven nozzle assemblies according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and, the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are>not intended to limit the scope of embodiments of the invention. Skilled artisans will recognize the examples provided herein have many useful alternatives and fall within the scope of embodiments of the invention.

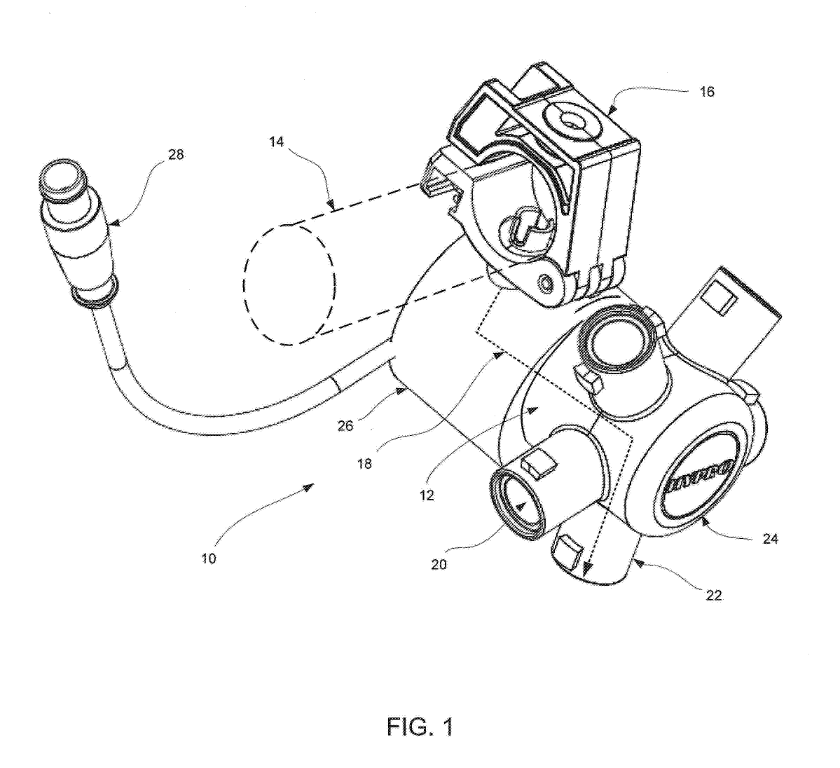

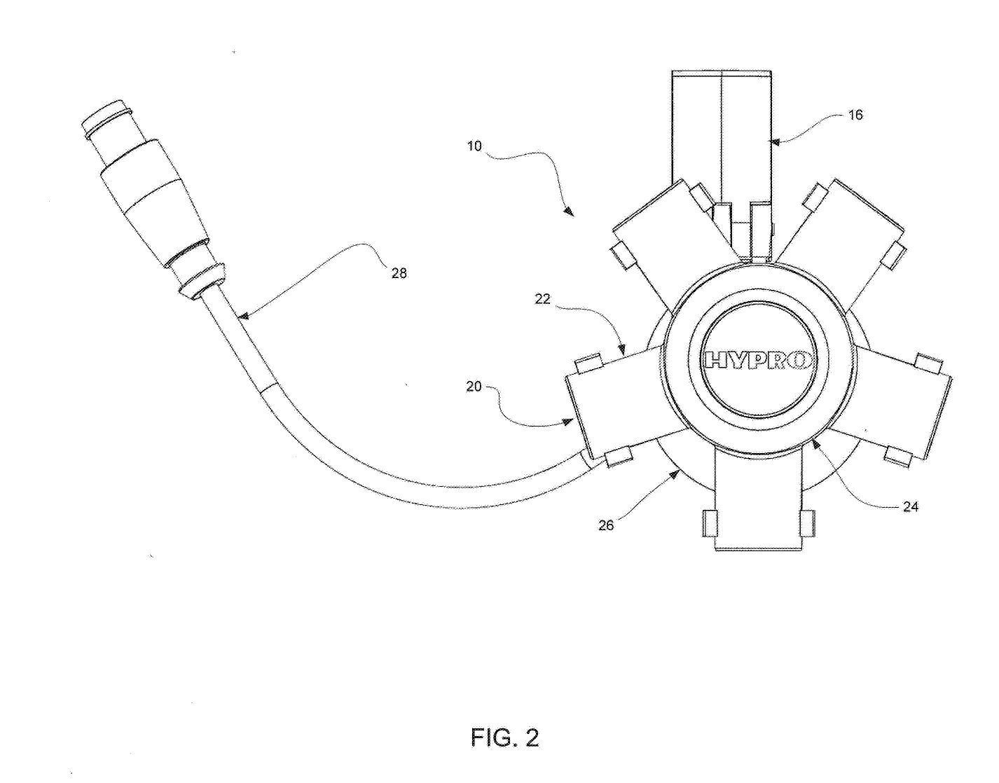

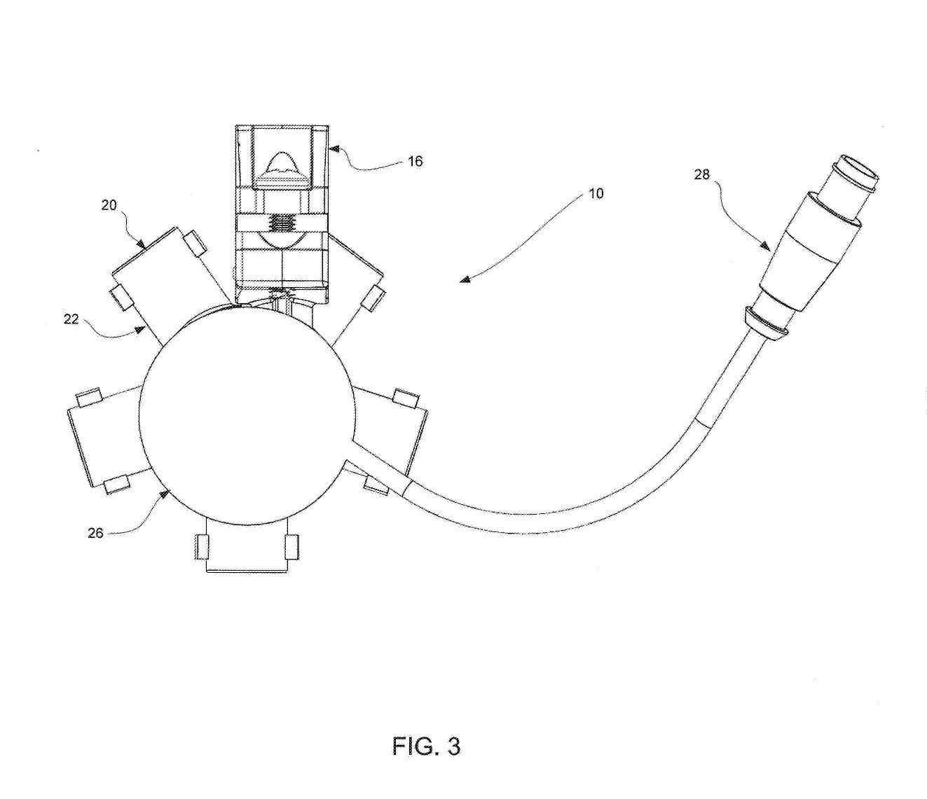

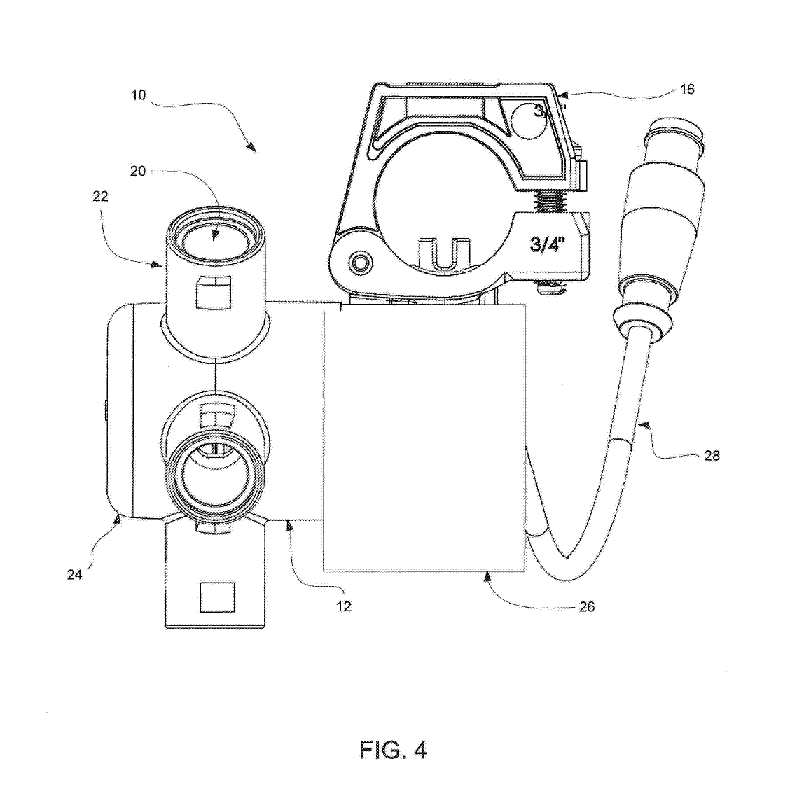

FIGS. 1 through 4 illustrate a driven turret nozzle assembly 10 according to one embodiment of the invention. The driven turret nozzle assembly 10 includes a main body 12 that can be coupled to a typical spray boom 14 (partially shown by dashed lines in FIG. 1) via a spray boom connector 16 that clamps the driven turret nozzle assembly 10 to the spray boom 14. The main body 12 defines a portion of a fluid path 18 that provides fluid communication between the spray boom 14 and, ultimately, to a spray tip 20 of an active nozzle body 22 extending from a turret 24.

The turret 24 is rotatably coupled to the main body 12 and includes a plurality of circumferentially spaced nozzle bodies 22. The turret 24 is selectively rotatable relative to the main body 12 to index a particular nozzle body 22 into an active position at which the nozzle body 22 (and its respective spray tip 20) defines a portion of the fluid path 18. The turret 24 may be configured to include nozzle bodies 22 having either similar or distinct spray tips 20. For example, each spray tip 20 of the turret 24 can define a discrete fluid parameter (e.g., a fluid flow rate, a fluid spray geometry/pattern), such that rotation of the turret 24 to employ a different nozzle body 22 alters the fluid parameter delivered by the newly active nozzle body 22. In other configurations, each nozzle body 22 can include similar spray tips 20 delivering substantially uniform fluid parameters. In still other variations, at least one of the nozzle bodies 22 can be capped (or replaced by a cap/plug), such that when in the active position no fluid is dispensed from the driven turret nozzle assembly 10. Moreover, the driven turret nozzle assembly 10 can be configured such that the driven turret nozzle assembly 10 is in an off or no-flow position when the turret 24 is indexed at an orientation whereat the fluid path 18 through the main body 12 is between adjacent nozzle bodies 22.

Rotation of the turret 24 can be achieved, for example, by a driver 26 coupled to or integral with the main body 12, and operationally coupled to the rotatable turret 24. In other forms, the driver 26 can be housed with or integral to the turret 24. The driver 26 can be, for instance, an electric motor (e.g., a stepper motor, a servo motor, an induction motor, a permanent magnet motor, a cylindrical motor, etc.), a hydraulic motor, a pneumatic motor, an electromechanical motor, and the like. The driver 26 can be engaged with the turret 24 to provide a driving force to controllably alter the orientation (e.g., rotational position) of the turret 24 relative to the main body 12. In one embodiment, the driver 26 and the turret 24 can be directly coupled or an intermediary can be implemented to transfer a driving force. Rotary motion, linear motion, or other relative movement can be produced by the driver 26 to effect rotational or other movement of the turret 24. For instance, relative motion can be achieved by direct or intermediate linkages, gears, or other drivetrain components, or hydraulic, electric, magnetic, thermal, and pneumatic actuators.

In another form, rotation of a turret can be achieved by a driver that is separate (e.g., from a body of a turret) and is a component added (e.g., coupled to a spray boom connector, engaged via mounting supports) as an accessory to engage the turret to control rotation and positioning of associated nozzle bodies. This accessory component driver can encompass a retrofit configuration adapted to engage and manipulate a typical or standard turret construction. For example, the accessory component driver may include a driven wheel biased against a rotational housing of a turret, such that as the wheel is selectively driven (e.g., via an electric motor), frictional engagement between the wheel and the turret results in manipulation of the turret and associated nozzle bodies. In other versions, a worm drive configuration can be employed with use of worm gear fixed to the turret and a driven worm coupled to a spray boom connector, such that, as the worm is driven (e.g., via a stepper motor), the worm drive configuration manipulates the orientation of the associated nozzle bodies. Various sensors can be incorporated to implement a control scheme. Control of the accessory component driver may be handled via an overall control scheme and, in other forms, may employ a separate, standalone communication and control scheme to provide control of the turret. For example, the accessory component driver may include a separate integrated controller for independently or cooperatively controlling the turret, or may be configured to implement control commands provided by a remote device controller.

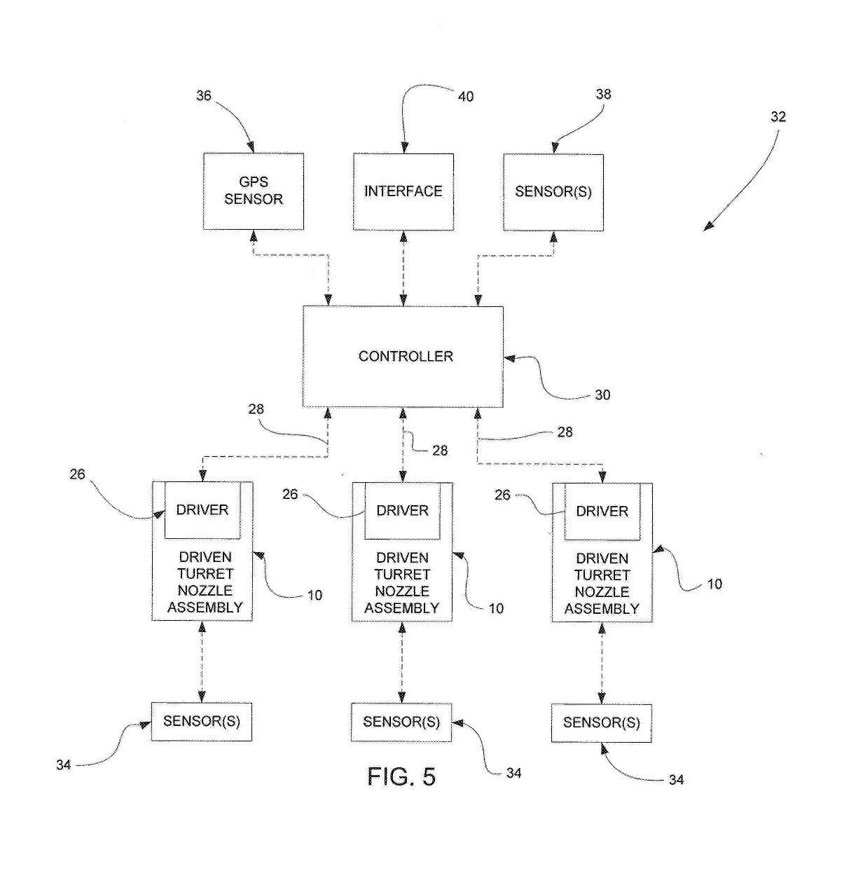

With additional reference to FIG. 5, a communication link 28 can be incorporated to establish a physical communication link between the driver 26 of the driven turret nozzle assembly 10 and a controller 30. In one embodiment, the communication link 28 is a cable providing two-way communication capabilities between the driver 26 and the controller 30, and the communication link 28 can also provide electrical power when the driver 26 is, for example, an electric stepper motor. In other embodiments, the communication link 28, as well as the various communications described below in connection with FIG. 5, can be direct (e.g., via a physical connection) or indirect (e.g., via a wireless connection). The communication can be two-way, meaning that the connected devices can both send and receive information (e.g., data, parameters etc.) and can be compatible with current, past, and future network protocols.

With specific reference to FIG. 5, an example system 32 incorporating a plurality of driven turret nozzle assemblies 10 is schematically illustrated. Each driven turret nozzle assembly 10 is in communication with the controller 30 via a respective communication link 28, which again can be partially or fully direct or indirect. The controller 30 is configured to communicate with the respective drivers 26 to control the actuation of the drivers 26 and ultimately the operation of the coupled turrets 24. In other embodiments, each driven turret nozzle assembly 10 can include a local controller that communicates with the controller 30 and provides local control of the driver 26 based on local information obtained via local sensors 34 (e.g., driver temperature sensors, driver current sensors, turret position sensors, etc.) or, alone or in combination with the local information, information provided by the controller 30. The driven turret nozzle assembly 10 may also include a local power source that can be used to power the driver 26 and optional local controller.

In the embodiment schematically illustrated in FIG. 5, the controller 30 can be in communication with a global positioning system (GPS) sensor 36 that provides, for instance, spray boom 14 and driven turret nozzle assembly 10 positional information, such that the controller 30 can be programmed to adapt and adjust the active nozzle bodies 22 based upon past, current, and/or anticipated future positioning information. Additional sensors 38 can be in communication with the controller 30 to provide information that may be used to control the individual driven turret nozzle assemblies 10. For example, the sensors 38 can include fluid level sensors that provide an indication of a level of available fluid in a supply tank, such that the driven turret nozzle assemblies 10 can be indexed to an off state when the fluid level drops below a preset level. In addition, the sensors 38 can include vehicle and environmental sensors that are integrated to provide information to the controller 30. As one example a vehicle speed sensor and an ambient wind velocity/direction sensor can provide information to the controller 30, which the controller 30 can be programmed to evaluate and alter the active nozzle body 22 on one or more of the driven turret nozzle assemblies 10. If, for instance, the relative velocity differential between the vehicle movement (as determined by the UPS sensor 36 and vehicle speed sensor) and the ambient wind velocity exceeds a defined threshold, the controller 30 may actuate various drivers 26 to activate spray tips 20 having a more focused spray pattern, reducing undesirable dispersion of the fluid due to the interaction of vehicle movement and ambient conditions.

In addition to receiving information from various sensors, the controller 30 can include an interface 40. The interface 40 can be used to receive direct user input, such as a user inputting or uploading to the controller 30 a controller program and/or a specific arrangement of a particular driven turret nozzle assembly 10 and respective spray tip 20 positioning. The interface 40 can also implement the programming of various parameters into the controller 30, such as the relative positioning of multiple driven turret nozzle assemblies 10 and the relative arrangement of the spray tips 20 located on each nozzle body 22 of the various turrets 24, such that these parameters are stored in the controller 30 and available during operation. In some embodiments, a geographical representation of the area to be sprayed and the dispersion plan can be provided to the controller 30 such that the controller 30 can communicate with the GPS sensor 36 to then actively control the various drivers 26 to ultimately provide the requisite levels of fluid application over the area (e.g., actuate a higher-flow or a lower-flow spray tip 20 as an individual or a particular subset of driven turret nozzle assemblies 10 traverse a defined area, alter the spray tip 20 of an outermost driven turret nozzle assembly 10 when that particular driven turret nozzle assembly 10 traverses a border of a defined area to reduce undesirable fluid overspray, while also accounting for vehicle and environmental variables).

The controller 30 may command a non-uniform spray tip 20 selection as between driven turret nozzle assemblies 10, that is, the array of driven turret nozzle assemblies 10 may be in various states of flow. In addition, the drivers 26 may be selectively driven in opposite directions (e.g., clockwise and counterclockwise) and can be controlled to operate in a non-sequential manner such that the turret 24 is continuously rotated through the active position for a particular nozzle body 22 during movement to engage and activate a desired (non-sequentially positioned) nozzle body 22.

Various arrangements can be employed to allow the controller 30 to have accurate and uninterrupted position information of each turret 24 (and thus the spray tips 20). For instance, use of a stepper motor as the driver 26 allows for accurate rotation, of the turret 24, which when combined with information defining the relative starting position and the relative arrangement of spray tips 20, can provide the controller 30 with the requisite information. Similarly, the controller 30 can be configured to perform self-checks and/or monitor for abnormalities in operation that can be indicative of an error or fault in a respective driven turret nozzle assembly 10, which can be provided to the interface 40 for display and subsequent investigation. If an error or fault is identified by the controller 30, the various driven turret nozzle assemblies 10 can be deactivated.

In other embodiments, the configuration of the driven turret nozzle assembly 10 can be programmed to the controller 30 by a user or communicated to the controller 30 by a controller associated with the particular driven turret nozzle assembly 10, such that a driven turret nozzle assembly 10 can be substantially automatically paired with a controller 30. Further still, a spray tip 20 can autonomously provide information to the controller 30 defining the particular flow properties and characteristics of the spray tip 20, such as by use of a radio frequency identification (RFID) chip associated with the spray tip 20 or an overall driven turret nozzle assembly 10 that is read by an RFID reader in communication or integral with the controller 30. Moreover, the position of a particular turret 24 relative to the associated main body 12 can be determined and communicated via a position sensor (e.g., a magnetic pickup arrangement) located on the main body 12 and turret 24, which is communicated to the controller 30.

The driver 26 of each driven turret nozzle assembly 10 can be actuated and controlled in direct response to user input, for example, as entered into the interface 40, automatically based on an automated control scheme programmed into and executed by the controller 30, or some combination thereof, such as when a user enters a command via the interface 40 to override the automated control scheme. In some forms, the controller 30 receives various parameters from one or more sensor (e.g., GPS sensor 36, sensors 38) and uses these parameters to determine the desired control strategy and thus actuation of the multiple drivers 26, which ultimately influences the delivery of fluid from each spray tip 20.

The driven turret nozzle assembly 10 can be sized and configured to be a direct replacement to typical nozzle assemblies, such as the Model 4263N ProFlo Series manufactured by Hypro located in New Brighton, Minn. Moreover, the driven turret nozzle assembly 10 can be configured to fit within the envelope defined by current nozzle assemblies to avoid, for instance, interference with other equipment. The various components may be made from application-specific materials, such as plastics and metals, that are suitable for a particular application.

It will be appreciated by those skilled in the art that while the invention has been described above in connection with particular embodiments and examples, the invention is not necessarily so limited, and that numerous other embodiments, examples, uses, modifications, and departures from the embodiments, examples, and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A driven turret nozzle assembly comprising:
a main body;
a turret rotatably coupled to and in fluid communication with the main body;
a plurality of nozzle bodies circumferentially spaced about the turret; and
a driver operationally coupled to the turret to effect automated selective rotation of the turret;
wherein actuation of the driver rotates the turret to move an active nozzle body of the plurality of nozzle bodies into fluid communication with a fluid path defined through the main body and the turret.

2. The driven turret nozzle assembly of claim 1, wherein each of the plurality of nozzle bodies includes a spray tip defining a discrete fluid parameter relative to an adjacent spray tip of one of the plurality of nozzle bodies.

3. The driven turret nozzle assembly of claim 1, wherein the driver comprises an electric stepper motor.

4. The driven turret nozzle assembly of claim 1, wherein the driver is operationally coupled to the turret through a drivetrain that transfers a driving force from the driver to the turret causing relative rotation between the driver and the turret.

5. The driven turret nozzle assembly of claim 1, further comprising a spray boom connector coupled to the driver and configured to releasably couple to a spray boom.

6. driven turret nozzle assembly of claim 1, further comprising a turret position sensor coupled to at least one of the driver and the turret to sense the position of the turret relative to the driver.

7. The driven turret nozzle assembly of claim 1, wherein the driver is separate from the main body.

8. The driven turret nozzle assembly of claim 7, wherein the driver is a retrofit accessory component adapted to engage and manipulate the turret.

9. The driven turret nozzle assembly of claim 1, further comprising a controller operably engaged with the driver and programmed to control the actuation of the driver to selectively rotate the turret to move an active one of the plurality of nozzle bodies into an active position at which the active nozzle body is in fluid communication with a fluid path defined through the main body and the turret.

10. The driven turret nozzle assembly of claim 9, wherein the controller is integral with the driver.

11. A driven turret nozzle assembly system, comprising:
a driven turret nozzle assembly comprising:
a main body;
a turret rotatably coupled to and in fluid communication with the main body;
a plurality of nozzle bodies circumferentially spaced about the turret; and
a driver operationally coupled to the turret to effect selective rotation of the turret;
a controller in communication with the driver and programmed to control actuation of the driver to rotate the turret to move an active one of the plurality of nozzle bodies into an active position at which the active nozzle body is in fluid communication with a fluid path defined through the main body and the turret.

12. The driven turret nozzle assembly system of claim 11, further comprising a communication link providing two-way communication between the driver and the controller.

13. The driven turret nozzle assembly system of claim 11, further comprising a global positioning sensor in communication with the controller to provide positional information used by the controller to actuate the driver to rotate the turret based upon anticipated future positioning information.

14. The driven turret nozzle assembly system of claim 11, further comprising a turret position sensor coupled to at least one of the driver and the turret to sense the position of the turret relative to the driver.

15. The driven turret nozzle assembly system of claim 11, wherein the driver is separate from the main body.

16. driven turret nozzle assembly system of claim 11, wherein the controller is integral with the driver.

17. A method of operating a driven turret nozzle assembly system, the system comprising a driven turret nozzle assembly comprising a main body, a turret rotatably coupled to and in fluid communication with the main body, a plurality of nozzle bodies circumferentially spaced about the turret, and a driver operationally coupled to the turret to effect rotation of the turret, a controller in communication with the driver and programmed to control actuation of the driver to rotate the turret, and a sensor in communication with the controller, the method including the steps of:
the controller receiving a parameter from the sensor;
the controller comparing the parameter to an automated control scheme programed into and executed by the controller; and
the controller actuating the driver to rotate the turret in accordance with a comparison between the automated control scheme and the parameter from the sensor.

18. The method of operating a driven turret nozzle assembly system of claim 17, wherein the step of the controller actuating the driver to rotate the turret moves an active one of the plurality of nozzle bodies into an active position at which the active nozzle body is in fluid communication with a fluid path defined through the main body and the turret.

19. The method of operating a driven turret nozzle assembly system of claim 17, wherein the parameter received from the sensor is positional information of the driven turret nozzle assembly.
